(19) United States
(12) Patent Application Publication
(10) Pub. No.: US 2015/0117856 A1
(43) Pub. Date: Apr. 30, 2015

(54) SYSTEM AND METHOD FOR MONITORING POWER IMBALANCE INDUCED BY POLARIZATION-DEPENDENT LOSS

(71) Applicant: Fujitsu Limited, Kawasaki-shi (JP)

(72) Inventors: Olga Vassilieva, Plano, TX (US); Inwoong Kim, Allen, TX (US); Jeng-Yuan Yang, Garland, TX (US); Motoyoshi Sekiya, Richardson, TX (US)

(73) Assignee: Fujitsu Limited, Kawasaki-shi (JP)

(21) Appl. No.: 14/067,451

(22) Filed: Oct. 30, 2013

(51) Int. Cl. H04B 10/077

(52) U.S. Cl. CPC H04B 10/0775
USPC 398/33

(57) ABSTRACT

Systems and methods for monitoring a dual-polarization signal are disclosed. The systems and methods include extracting a portion of the dual-polarization signal, wherein the dual-polarization signal includes multiple supervisory signals, each associated with a polarization component of a main data signal, measuring a power level of the first and second supervisory signals, and determining a power imbalance between the polarization components of the main data signal based at least on the power level.

### TECHNICAL FIELD

This invention relates generally to the field of optical networks and more specifically to monitoring a dual-polarization signal using an in-band supervisory signal.

### BACKGROUND

As the importance and ubiquity of optical communication systems increases, it becomes increasingly important to be able to accurately and efficiently monitor the optical communication system in order to ensure proper operation of the optical communication system. The importance of accurate and efficient monitoring increases as optical traffic signals are implemented comprising components with multiple polarizations (e.g., dual-polarization signals). It is increasingly important to be able to monitor the optical communication system in a cost-effective manner, as well as monitor in-line with other components of the optical communication system.

### SUMMARY OF THE DISCLOSURE

In accordance with certain embodiments of the present disclosure, systems and methods for monitoring a dual-polarization signal are disclosed. The systems and methods include extracting a portion of the dual-polarization signal, wherein the dual-polarization signal includes multiple supervisory signals, each associated with a polarization component of a main data signal, measuring a power level of the first and second supervisory signals, and determining a power imbalance between the polarization components of the main data signal based at least on the power level.

### BRIEF DESCRIPTION OF THE DRAWINGS

For a more complete understanding of the present invention and its advantages, reference is now made to the following description, taken in conjunction with the accompanying drawings, in which:

FIG. 1 illustrates an example optical network, in accordance with certain embodiments of the present disclosure;

FIG. 2 illustrates an example supervisory signal receiver for receiving complementary, amplitude-modulated supervisory signals, wherein supervisory signals have the same amplitude and the same frequency, in accordance with certain embodiments of the present disclosure;

FIG. 3 illustrates an example supervisory signal receiver for receiving arbitrary, amplitude-modulated supervisory signals, wherein supervisory signals may have the same or different amplitudes and different frequencies, in accordance with certain embodiments of the present disclosure;

FIG. 4 illustrates a second example supervisory signal receiver for receiving complementary, frequency-modulated supervisory signals, in accordance with certain embodiments of the present disclosure;

FIG. 5 illustrates an example supervisory signal receiver 600 for receiving arbitrary, frequency-modulated supervisory signals, in accordance with certain embodiments of the present disclosure; and

FIG. 6 illustrates a flowchart of an example method for analyzing a supervisory signal associated with an optical traffic signal, in accordance with certain embodiments of the present disclosure.

### DETAILED DESCRIPTION OF THE INVENTION

As used herein, the term “computer-readable media” may be any available media that may be accessed by a general purpose or special purpose computer. By way of example, and not limitation, such computer-readable media may comprise tangible computer-readable including RAM, ROM, EEPROM, CD-ROM or other optical disk storage, magnetic disk storage or other magnetic storage devices, or any other medium which may be used to carry or store desired program code means in the form of computer-executable instructions or data structures and which may be accessed by a general purpose or special purpose computer. Combinations of the above should also be included within the scope of computer-readable media.

Additionally, “computer-executable instructions” may include, for example, instructions and data which cause a general purpose computer, special purpose computer, or special purpose processing device to perform a certain function or group of functions.

As used herein, the term “module” or “component” may refer to software objects or routines that execute on a computing system. The different components, modules, engines, and services described herein may be implemented as objects or processes that execute on the computing system (e.g., as separate threads), as well as being implemented as hardware, firmware, and/or some combination of all three.

The following describes a cost-effective, in-line solution for monitoring an optical traffic signal of an optical communication system. The present disclosure describes systems and methods for monitoring a relatively low-modulation depth supervisory signal within existing components of the optical communication system in order to monitor wavelength and lightpath information associated with the optical communication system.

Telecommunications systems, cable television systems and data communication networks use optical networks to rapidly convey large amounts of information between remote points. In an optical network, information is conveyed in the form of optical signals through optical fibers or other optical media. The optical networks may include various components such as amplifiers, dispersion compensators, multiplexer/demultiplexer filters, wavelength selective switches, couplers, etc. configured to perform various operations within the optical network. The optical network may communicate supervisory data indicating any number of characteristics associated with the optical network, including source information, destination information and routing information, and other management information of the optical network.

The supervisory data may be used to, among other things, determine an amount of polarization dependent loss (“PDL”) associated with a segment of the optical network. In some optical networks, PDL may be a limiting factor in implementation. For example, in 100+Gb/s optical networks, PDL may be a limiting factor in practical realizations of such optical networks. PDL may cause a power inequality between polarization channels in a polarization-multiplexed optical network. This effect may be more prominent when a polarization axis of a signal and a polarization axis of the PDL are aligned. The resulting lower power may result in a lower optical signal-to-noise ratio (“OSNR”) and thus an increased bit error rate (“BER”). In some optical networks, it may be difficult or impossible to compensate for PDL losses with a digital signal processor (“DSP”) in a coherent receiver.

PDL may accumulate due to the effects of components present in an optical network such as amplifiers, dispersion compensators, multiplexor/demultiplexer filters, wavelength selective switches, couplers, etc. Additionally, the polarization state of PDL may change due to effects generated by fiber, components, polarization mode dispersion, and/or other effects. PDL may also accumulate randomly. In some models of PDL, the distribution may be approximated by a Maxwell distribution where N>>1.

Monitoring of PDL effects may be difficult in implementations of optical networks due to the relatively high-cost of monitoring elements and may be difficult to implement in-line within the optical network. Moreover, it may be difficult to monitor PDL within each polarization channel.

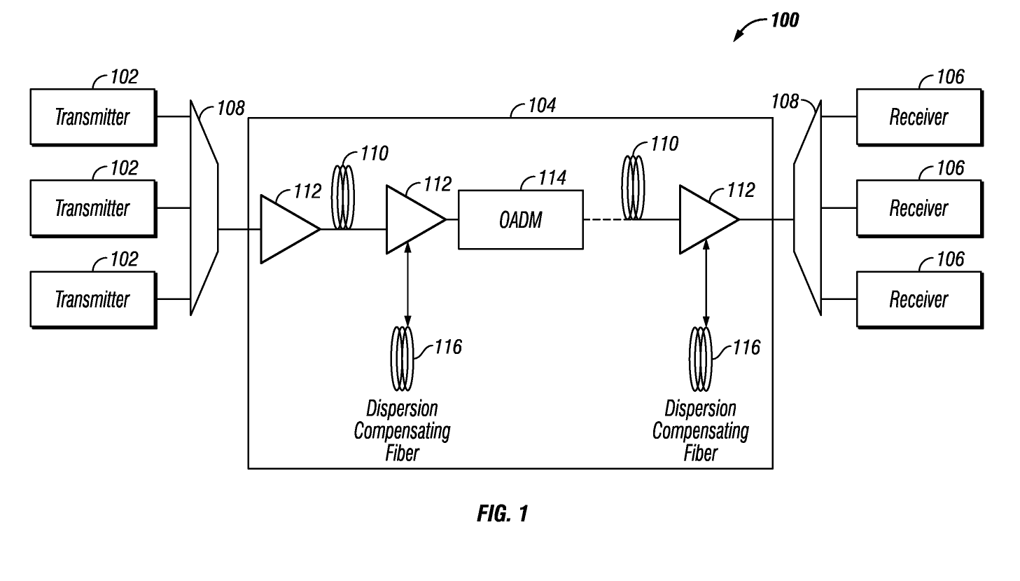

FIG. 1 illustrates an example optical network 100, in accordance with certain embodiments of the present disclosure. Network 100 may include transmitter 102, transmission system 104, and receiver 106. Network 100 may include one or more optical fibers 110 configured to transport one or more optical signals communicated by components of optical network 100. The network elements of optical network 100, coupled together by fibers 106, may include one or more transmitters 102, one or more multiplexers (MUX) 108, one or more amplifiers 112, one or more optical add/drop multiplexers (OADM) 114, and/or one or more dispersion compensating fibers 116.

The example system of FIG. 1 illustrates a simplified point-to-point optical system. Although one particular form or topography of network 100 is illustrated, network 100 may take any appropriate form, including a ring network, mesh network, and/or any other suitable optical network and/or combination of optical networks.

In some embodiments, transmitter 102 may be any electronic device, component, and/or combination of devices and/or components configured to transmit a multi-polarization optical signal to receiver 106. For example, transmitter 102 may include one or more lasers, processors, memories, digital-to-analog converters, analog-to-digital converters, digital signal processors, beam splitters, beam combiners, multiplexers, and/or any other components, devices, and/or systems required to transmit a dual-polarization optical signal to receiver 106.

In some embodiments, transmitter 102 may be further configured to include a supervisory signal in-band with the optical traffic signal. The systems and methods describing one particular implementation of the supervisory signal with a dual-polarization optical signal are described in more detail in U.S. patent application Ser. Nos. 13/620,102, and 13/620,172, both of which are hereby incorporated by reference. For the purposes of this disclosure, references to an “optical signal” and/or an “optical traffic signal” should be assumed to include the in-band supervisory signal unless expressly stated otherwise.

In some configurations of network 100, it may be costly to implement an in-band supervisory signal with a dual-polarization optical signal. For example, it may be necessary to install high-speed (and thus expensive) photo-detectors, processors, and/or polarimeters. However, in other configurations of network 100, one or more low-data rate supervisory signal(s) may be implemented, allowing for the use of low-speed (and thus lower-cost) photo-detectors, processors, and/or polarimeters. In some embodiments, a low-data rate supervisory signal may have a modulation period much longer than the data period of the optical traffic signal. In the same or alternative embodiments, the low-data rate supervisory signal(s) may allow the supervisory signal(s) to be more easily separated from a main data signal.

In some embodiments, transmitter 102 may communicate an optical traffic signal (along with one or more in-band supervisory signals) to receiver 106 via transmission system 104. Transmission system 104 may generally include the following components: one or more fiber 110, one or more OADM 114 module(s), and/or one or more amplifier(s) 112. With reference to FIG. 1, these components are provided to aid in illustration and are not intended to limit the scope of the present disclosure. In some configurations of network 100, network 100 may include more, fewer, and/or different components than those illustrated in FIG. 1.

In addition, the components of transmission system 104 may be communicatively coupled to one another through the use of fiber 110. In some embodiments, fiber 110 may be any appropriate optical fiber configured to carry data, such as a single-mode optical fiber or a non-zero dispersion shifted fiber. Transmission system 104 may also include amplifier 112. In some embodiments, amplifier 112 may be any amplifier configured to amplify the optical traffic signal (along with the one or more in-band supervisory signal) for more efficient transmission to receiver 106. For example, amplifier 112 may be an erbium doped fiber amplifier (“EDFA”) common to optical communication systems. In some embodiments, amplifier 112 may be responsible for certain types of noise introduced to the optical traffic signal. For example, an EDFA introduces a type of noise known to one of ordinary skill in the art as amplified spontaneous emission (“ASE”).

In some embodiments, amplifier 112 may be communicatively coupled to dispersion compensating fiber 116. Dispersion compensating fiber 116 may be any appropriate fiber and/or collection of fibers configured to compensate for any nonlinear effects associated with transmission system 104 such as chromatic dispersion.

In some embodiments, network 100 may also include one or more OADM 114. OADM 114 may be any appropriate component and/or collection of components configured to multiplex and/or route multiple wavelengths of light between and/or among nodes of network 100.

In some embodiments, receiver 106 may be any electronic device, component, and/or combination of devices and/or components configured to receive a multi-polarization optical signal from transmitter 102. For example, transmitter 102 may include one or more lasers, optical modulators, processors, memories, digital-to-analog converters, analog-to-digital converters, digital signal processors, beam splitters, beam combiners, demultiplexers, and/or any other components, devices, and/or systems required to receive a dual-polarization optical signal from transmitter 102.

In some embodiments, transmitter 102 and receiver 106 may be present in the same device, for example in an optical communication network including a plurality of optical nodes that are interconnected. In the same or alternative embodiments, transmitter 102 and receiver 106 may be separate devices, located either locally or remote from one another.

In operation, transmitter 102 may communicate a dual-polarization optical traffic signal (along with the one or more in-band supervisory signal(s)) to receiver 106 via transmission system 104. Each polarization tributary of the dual-polarization optical traffic signal may be multiplexed with a supervisory signal. The supervisory signal may be complementary or non-complementary, added in the optical or electrical domain, and may be modulated with any appropriate modulation scheme (e.g., an amplitude or phase modulation technique).

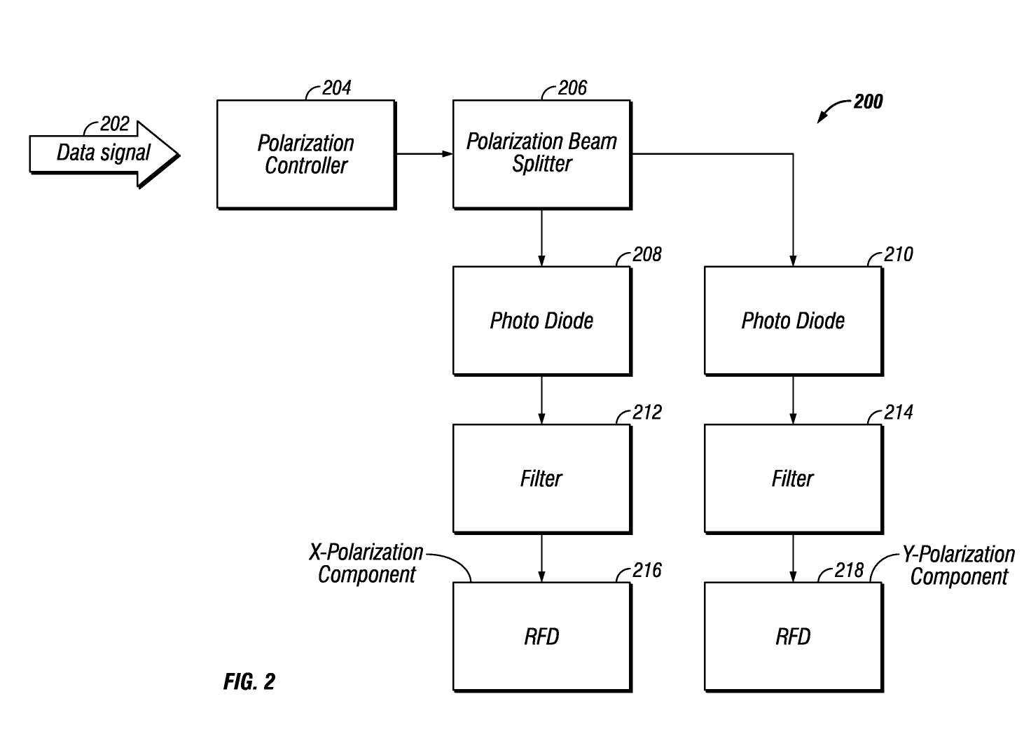

At receiver 106, the supervisory signal(s) may be extracted by tapping a small portion of the signal (e.g., 5%) and detected using relatively lower cost and/or lower speed components, as described in more detail below with reference to FIGS. 2-5. Power imbalance between polarization channels may then be determined based on a power imbalance between or among supervisory signals.

In some embodiments, transmitter 102 may be configured to create supervisory signal data for each polarization tributary of the dual-polarization signal. The modulation depth of the supervisory signal data may be relatively much smaller than the modulation depth of the main traffic signal data. For example, the supervisory signal data may be modulated at a depth that is 5% of the modulation depth of the main traffic signal data. Likewise, the frequency of the supervisory signal data may be relatively substantially less than that of the main traffic signal data. For example, the supervisory signal data may have a frequency in the MHz range while the main traffic data signal has a frequency in the GHz range.

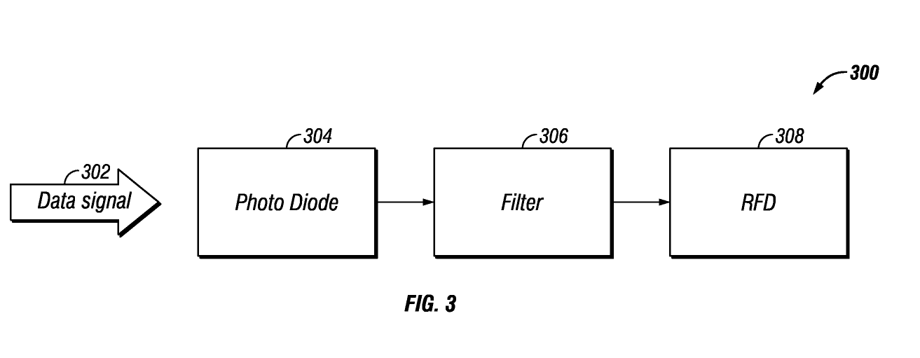

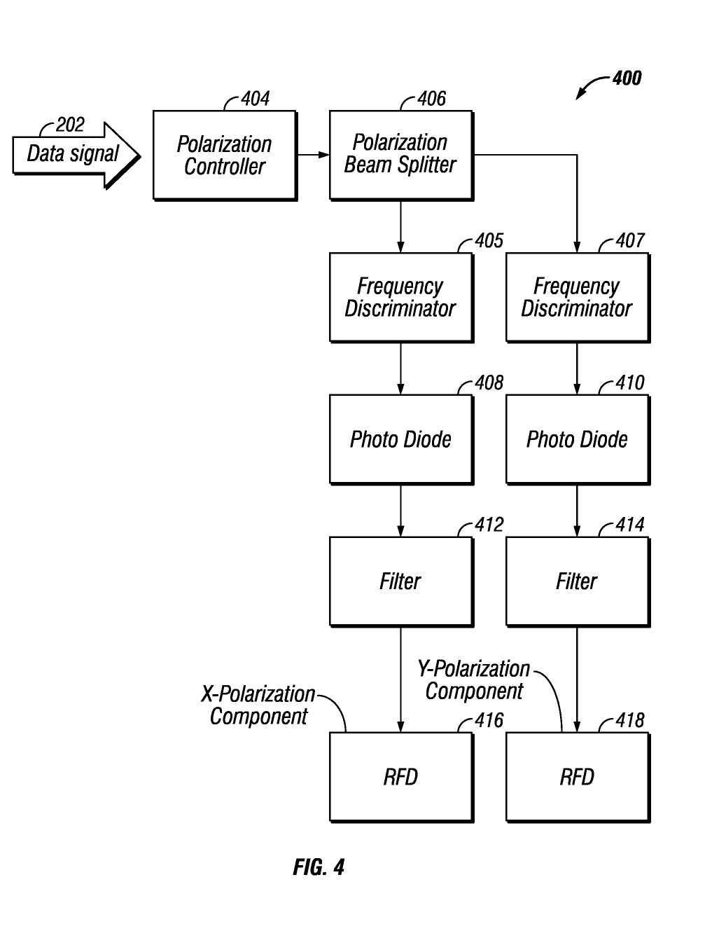

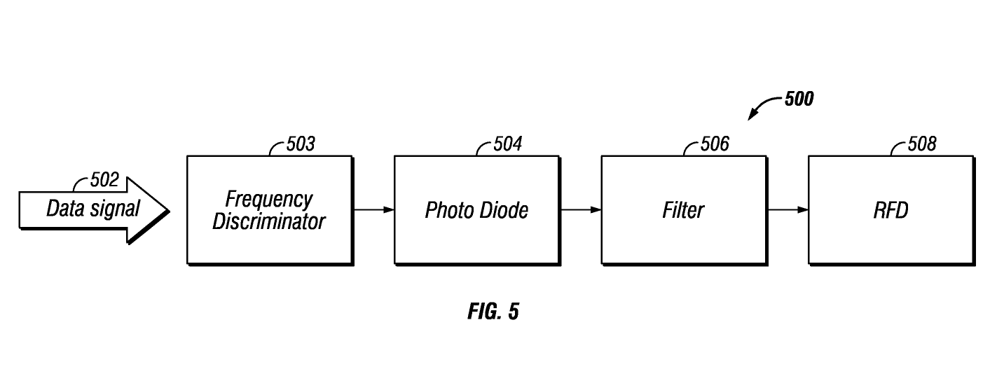

The following configurations are presented as illustrative examples to aid in understanding and are not intended to limit the scope of the present disclosure. In some configurations of network 100, amplitude-modulated supervisory signals with the same amplitude and frequency may be implemented, as described in more detail below with reference to FIG. 2. In the same or alternative configurations of system 100, amplitude-modulated supervisory signals with different frequencies may be implemented, as described in more detail below with reference to FIG. 3. In the same or alternative embodiments, complementary frequency-modulated supervisory signals may be implemented, as described in more detail below with reference to FIG. 5. In the same or alternative embodiments, arbitrary frequency-modulated supervisory signals may be implemented, as described in more detail below with reference to FIG. 4.

Through the introduction of one or more supervisory signals associated with each polarization channel of a multi-polarization signal, system 100 may be used to monitor PDL. For example, a power imbalance between polarization channels may be determined based on a power imbalance between or among supervisory signals. In some embodiments, supervisory signals may be added in the optical and/or electrical domain.

At receiver 104, supervisory signals may be extracted by tapping a small portion of the signal (e.g., 5%) and detected using relatively low-speed photo detector(s) and/or electrical filters(s). Power fluctuation of supervisory signals, induced by in-line components with PDL, may be measured with a radio frequency power detector (“RFD”).

FIG. 2 illustrates an example supervisory signal receiver 200 for receiving complementary, amplitude-modulated supervisory signals, wherein supervisory signals have the same amplitude and the same frequency, in accordance with certain embodiments of the present disclosure. In some embodiments, transmitter 200 may include main data signal 202, polarization controller 204, polarization beam splitter 206, photo diodes 208, 210, band-pass filters 212, 214, and RFDs 216, 218.

In some embodiments, as described in more detail above with reference to FIG. 1, the supervisory signals may have the amplitude modulation depth and the same frequency. For example, the supervisory signals may have an amplitude of approximately 5% of the main signal data and a frequency of approximately 10 MHz. In some embodiments, the supervisory signals may be said to be “complementary.” For the purposes of the present disclosure, a complementary signal may be understood to be one in which the value of the supervisory signal associated with the x-component of the main data signal is equal or opposite to the supervisory signal associated with the y-component of the main data signal.

In some embodiments, data signal 202 may include an optical traffic signal along with one or more superimposed supervisory signals, as described in more detail above with reference to FIG. 1. Data signal 202 may be incident on polarization controller 204. In some embodiments, polarization controller 204 may be any component configured to normalize the state of polarization (“SOP”) of data signal 202. For example, polarization controller 204 may be a polarization controller configured to set the state of polarization to forty-five degrees. Polarization controller 204 may be communicatively coupled to polarization beam splitter 206, which may be configured to separate the polarization components of the SOP-normalized data signal.

In some configurations of network 100, polarization beam splitter 206 may be included in receiver 200 in order to separate the polarization components of the supervisory signal. Polarization beam splitter 206 may be communicatively coupled to a plurality of photo diodes 208, 210.

In some embodiments, photo diodes 208, 210 may be any component configured to convert an optical signal into an electric signal. For example, photo diodes 208, 210 may be a relatively low-speed photo diode due to the relatively low modulation speed of the supervisory signal. Photo diodes 208, 210 may be communicatively coupled to one or more bandpass filter(s) 212, 214.

Band-pass filters 212, 214 may be configured to extract the supervisory signal data associated with the x- and y-components of the main signal data, respectively. For example, band-pass filter (“BPF”) 212 may be a tunable BPF configured to pass the supervisory signal associated with the x-component of the main signal data and BPF 214 may be a tunable BPF configured to pass the supervisory signal associated with the y-components of the main signal data. For example, bandpass filters 212, 214 may be configured to filter the frequency associated with the polarization components of the supervisory signal data (e.g., 10 MHz). Bandpass filters 212, 214 may be communicatively coupled to one or more RFDs 216, 218.

In some embodiments, RFDs 216, 218 may be any component configured to measure a power value associated with the filtered supervisory signal data. In some embodiments, receiver 200 may further include one or more components configured to analyze the measured power values. For example, these components may include a digital signal processor, microprocessor, microcontroller, and/or any appropriate component configured to analyze the extracted power values. For example, receiver 200 may be configured to calculate a power inequality between the measured power values of the supervisory signals associated with the x- and y-components of the main data signal.

In some embodiments, the relatively low cost of the components included in receiver 200 may allow receiver 200 to be implemented in-line in network 100. In the same or alternative embodiments, the components of receiver 200 may be included in a stand-alone optical receiver, and/or any other appropriate configuration of optical receiver(s).

FIG. 3 illustrates an example supervisory signal receiver 300 for receiving arbitrary, amplitude-modulated supervisory signals, wherein supervisory signals may have the same or different amplitudes and different frequencies, in accordance with certain embodiments of the present disclosure. In some embodiments, transmitter 300 may include main data signal 302, one or more photo diode(s) 304, one or more band-pass filter(s) 306, and one or more RFD(s) 308.

In some embodiments, as described in more detail above with reference to FIG. 1, the supervisory signals may have the same or different amplitude modulation depth and different frequencies. For example, the supervisory signal associated with the x-component of the main data signal may have an amplitude of approximately 5% of the main signal data and a frequency of 10 MHz, while the supervisory signal associated with the y-component of the main data signal may have an amplitude of approximately 3% of the main data signal and a frequency of approximately 17 MHz. In some embodiments, the supervisory signals may said to be “non-complementary” or “arbitrary.” For the purposes of the present disclosure, a non-complementary signal may be understood to be one in which the value of the supervisory signal associated with the x-component of the main data signal is neither equal to nor opposite to the supervisory signal associated with the y-component of the main data signal.

In some embodiments, data signal 302 may include an optical traffic signal along with one or more superimposed supervisory signals, as described in more detail above with reference to FIG. 1. Data signal 302 may be incident on one or more photo diode(s) 304. In some embodiments, photo diode 304 may be any component configured to convert an optical signal into an electric signal. For example, photo diode 304 may be a relatively low-speed photo diode due to the relatively low modulation speed of the supervisory signal. Photo diode 304 may be communicatively coupled to one or more bandpass filter(s) 306.

Band-pass filter 306 may be configured to extract the supervisory signal data associated with the x- and y-components of the main signal data. For example, band-pass filter (“BPF”) 306 may be a tunable BPF configured to pass the supervisory signal associated with the x- and y-component of the main signal data. For example, bandpass filter 306 may be configured to have a bandwidth less than or equal to the difference in frequencies of the supervisory signals (e.g., 7 MHz). Bandpass filters 306 may be communicatively coupled to one or more RFD(s) 308.

In some embodiments, RFD 308 may be any component configured to measure a power value associated with the filtered supervisory signal data. In some embodiments, receiver 300 may further include one or more components configured to analyze the measured power values. For example, these components may include a digital signal processor, microprocessor, microcontroller, and/or any appropriate component configured to analyze the extracted power values. For example, receiver 300 may be configured to calculate a power inequality between the measured power values of the supervisory signals associated with the x- and y-components of the main data signal.

In some embodiments, the relatively low cost of the components included in receiver 300 may allow receiver 300 to be implemented in-line in network 100. In the same or alternative embodiments, the components of receiver 300 may be included in a stand-alone optical receiver, and/or any other appropriate configuration of optical receiver(s). In some configurations of system 100 using arbitrary, amplitude-modulated supervisory signals, a total signal power may not be constant throughout transmission. In some instances, this may result in an OSNR penalty due to certain nonlinear impairments. However, some configurations of system 100 may be configured without a dispersion compensating module in order to relax any potential impact of nonlinear impairments.

FIG. 4 illustrates a second example supervisory signal receiver 400 for receiving complementary, frequency-modulated supervisory signals, in accordance with certain embodiments of the present disclosure. In some embodiments, transmitter 400 may include main data signal 402, polarization controller 404, polarization beam splitter 406, frequency discriminators 404, 407, photo diodes 408, 410, band-pass filters 412, 414, and RFDs 416, 418.

In some embodiments, as described in more detail above with reference to FIG. 1, the supervisory signals may be complementary, frequency-modulated signals. For the purposes of the present disclosure, a complementary signal may be understood to be one in which the value of the supervisory signal associated with the x-component of the main data signal is either equal to or opposite the supervisory signal associated with the y-component of the main data signal.

In some embodiments, data signal 402 may include an optical traffic signal along with one or more superimposed supervisory signals, as described in more detail above with reference to FIG. 1. Data signal 402 may be incident on polarization controller 404. In some embodiments, polarization controller 404 may be any component configured to normalize the state of polarization (“SOP”) of data signal 402. For example, polarization controller 404 may be a polarization controller configured to set the state of polarization to forty-five degrees. Polarization controller 404 may be communicatively coupled to polarization beam splitter 406, which may be configured to separate the polarization components of the SOP-normalized data signal.

In some configurations of network 100, polarization beam splitter 406 may be included in receiver 400 in order to separate the polarization components of the supervisory signal. Polarization beam splitter 406 may be communicatively coupled to a plurality of frequency discriminators 404, 407.

In some embodiments, frequency discriminators 404, 407 may be any component and/or combination of components configured to convert the frequency-modulated signal incident on frequency discriminators 404, 407 to amplitude-modulated signals. For example, frequency discriminator 404 may be configured to convert the signal associated with the x-component of the combined data signal and frequency discriminator 407 may be configured to convert the signal associated with the y-component of the combined data signal. Frequency discriminators 404, 407 may be communicatively coupled to photo diodes 408, 410.

In some embodiments, photo diodes 408, 410 may be any component configured to convert an optical signal into an electric signal. For example, photo diodes 408, 410 may be a relatively low-speed photo diode due to the relatively low modulation speed of the supervisory signal. Photo diodes 408, 410 may be communicatively coupled to one or more bandpass filter(s) 412, 414.

Band-pass filters 412, 414 may be configured to extract the supervisory signal data associated with the x- and y-components of the main signal data, respectively. For example, band-pass filter (“BPF”) 412 may be a tunable BPF configured to pass the supervisory signal associated with the x-component of the main signal data and BPF 414 may be a tunable BPF configured to pass the supervisory signal associated with the y-components of the main signal data. Bandpass filters 412, 414 may be communicatively coupled to one or more RFDs 416, 418.

In some embodiments, RFDs 416, 418 may be any component configured to measure a power value associated with the filtered supervisory signal data. In some embodiments, receiver 400 may further include one or more components configured to analyze the measured power values. For example, these components may include a digital signal processor, microprocessor, microcontroller, and/or any appropriate component configured to analyze the extracted power values. For example, receiver 400 may be configured to calculate a power inequality between the measured power values of the supervisory signals associated with the x- and y-components of the main data signal.

In some embodiments, the relatively low cost of the components included in receiver 400 may allow receiver 400 to be implemented in-line in network 100. In the same or alternative embodiments, the components of receiver 400 may be included in a stand-alone optical receiver, and/or any other appropriate configuration of optical receiver(s). In some configurations of system 100 using complementary, frequency-modulated supervisory signals, there may be no frequency offset for the combined multi-polarization signal. Further, in some configurations, the use of complementary a polarization frequency may help to reduce or eliminate carrier frequency drift.

FIG. 5 illustrates an example supervisory signal receiver 500 for receiving arbitrary, frequency-modulated supervisory signals, in accordance with certain embodiments of the present disclosure. In some embodiments, transmitter 500 may include main data signal 502, one or more frequency discriminator(s) 503, one or more photo diode(s) 504, one or more band-pass filter(s) 506, and one or more RFD(s) 508.

In some embodiments, the supervisory signals may be said to be “non-complementary” or “arbitrary.” For the purposes of the present disclosure, a non-complementary signal may be understood to be one in which the value of the supervisory signal associated with the x-component of the main data signal is neither equal to nor opposite to the supervisory signal associated with the y-component of the main data signal.

In some embodiments, data signal 502 may include an optical traffic signal along with one or more superimposed supervisory signals, as described in more detail above with reference to FIG. 1. Data signal 502 may be incident on one or more frequency discriminator(s) 503. Frequency discriminator 503 may be any component and/or components configured to convert the incoming signal from a frequency-modulated signal to an amplitude-modulated signal. For example, frequency discriminator 503 may be a narrow-band optical band-pass filter. Frequency discriminator 503 may be communicatively coupled to one or more photo diode(s) 504.

In some embodiments, photo diode 504 may be any component configured to convert an optical signal into an electric signal. For example, photo diode 504 may be a relatively low-speed photo diode due to the relatively low modulation speed of the supervisory signal. Photo diode 504 may be communicatively coupled to one or more bandpass filter(s) 506.

Band-pass filter 506 may be configured to extract the supervisory signal data associated with the x- and y-components of the main signal data. For example, band-pass filter (“BPF”) 506 may be a tunable BPF configured to pass the supervisory signal associated with the x- and y-component of the main signal data. For example, bandpass filter 506 may be configured to have a bandwidth less than or equal to the difference in frequencies of the supervisory signals (e.g., 7 MHz). Bandpass filters 506 may be communicatively coupled to one or more RFD(s) 508.

In some embodiments, RFD 508 may be any component configured to measure a power value associated with the filtered supervisory signal data. In some embodiments, receiver 500 may further include one or more components configured to analyze the measured power values. For example, these components may include a digital signal processor, microprocessor, microcontroller, and/or any appropriate component configured to analyze the extracted power values. For example, receiver 500 may be configured to calculate a power inequality between the measured power values of the supervisory signals associated with the x- and y-components of the main data signal.

In some embodiments, the relatively low cost of the components included in receiver 500 may allow receiver 500 to be implemented in-line in network 100. In the same or alternative embodiments, the components of receiver 500 may be included in a stand-alone optical receiver, and/or any other appropriate configuration of optical receiver(s). In some configurations of system 100 using arbitrary, frequency-modulated supervisory signals may introduce additional fluctuation in transmitter light frequency. In some instances, this may be reduced and/or eliminated through the use of a laser-frequency offset compensation algorithm built into typical digital signal processors that may also reside within receiver 500.

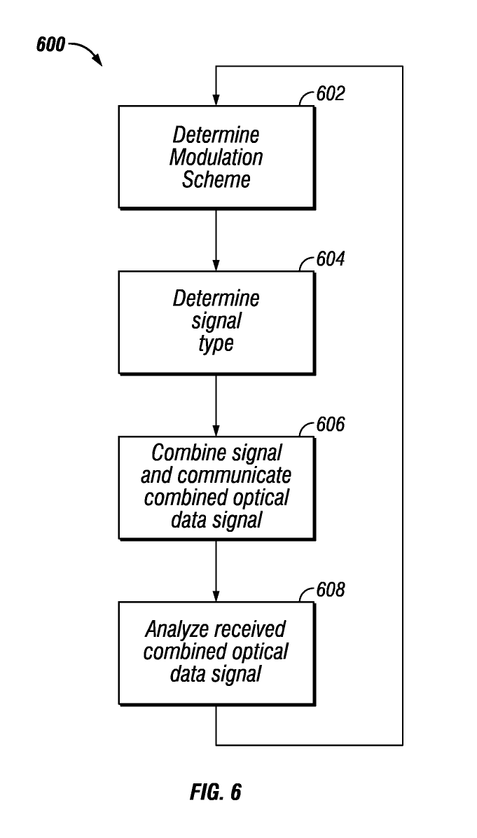

FIG. 6 illustrates a flowchart of an example method 600 for analyzing a supervisory signal associated with an optical traffic signal, in accordance with certain embodiments of the present disclosure. Method 600 may include introducing a plurality of supervisory signals and determining a power inequality in order to determine the effects of PDL.

According to one embodiment, method 600 may begin at 602. Teachings of the present disclosure may be implemented in a variety of configurations. As such, the preferred initialization point for method 600 and the order of 602-08 comprising method 600 may depend on the implementation chosen.

At 602, method 600 may determine whether to introduce an amplitude-modulated or frequency-modulated, as described in more detail above with reference to FIGS. 1-6. Once the selection is made, method 600 may proceed to step 604.

At step 604, method 600 may determine whether to introduce a complementary or non-complementary supervisory signal, as described in more detail above with reference to FIGS. 1-6. After making the determination, method 600 may proceed to step 606.

At step 606, method 600 may combine the selected supervisory signals with the multi-polarization data signal and communicate the combined optical data signal through the remainder of network 100. After communicating the combined optical data signal, method 600 may proceed to step 608.

At step 608, method 600 may analyze the received combined optical data signal in order to determine PDL information associated with system 100, as described in more detail above with reference to FIGS. 1-6. For example, method 600 may make use of a power differential between or among the analyzed supervisory signal data in order to establish a PDL effect level.

Although FIG. 6 discloses a particular number of steps to be taken with respect to method 600, method 600 may be executed with more or fewer than those depicted in FIG. 6. For example, in some configurations of network 100, the analysis of the supervisory signal data may occur simultaneously with further communication of the combined optical data signal (e.g., when performing in-line analysis). Further, in some configurations of network 100, both electrical domain and/or optical domain combinations of the main data signal data and supervisory signal data may be performed.

What is claimed:

1. A method for monitoring a dual-polarization signal, the method comprising:
extracting a portion of the dual-polarization signal, wherein the dual-polarization signal includes:
a first supervisory signal associated with a first polarization component of a main data signal; and
a second supervisory signal associated with a second polarization component of the main data signal;
measuring a power level of the first and second supervisory signals; and
determining a power imbalance between the first and second polarization components of the main data signal based at least on the power level.

2. The method of claim 1, wherein determining the power imbalance comprises determining the power imbalance based at least on a supervisory signal power imbalance, the supervisory signal power imbalance based at least on the power level.

3. The method of claim 1, wherein the first and second supervisory signals are amplitude-modulated.

4. The method of claim 1, wherein the first and second supervisory signals are frequency-modulated.

5. The method of claim 1, wherein the first and second supervisory signals are complementary.

6. The method of claim 1, wherein the first and second supervisory signals are non-complementary.

7. An optical receiver for receiving a multi-polarization signal, the optical receiver comprising:
a polarization controller;
a polarization beam splitter communicatively coupled to the polarization controller;
a plurality of photo diodes communicatively coupled to the polarization beam splitter;
a band-pass filter communicatively coupled to each of the plurality of photo diodes; and
a radio frequency power detector communicatively coupled to each band-pass filter, wherein the radio frequency power detector is configured to detect an optical power level associated with one or more supervisory signals, wherein each of the one or more supervisory signals is associated with one or more polarization components of the multi-polarization signal.

8. The optical receiver of claim 7, wherein the one or more supervisory signals are amplitude-modulated.

9. The optical receiver of claim 8, wherein the one or more supervisory signals are complementary.

10. The optical receiver of claim 7, wherein the polarization beam splitter is communicatively coupled to a plurality of frequency discriminators, wherein each of the plurality of frequency discriminators is further communicatively coupled to at least one of the plurality of photo diodes.

11. The optical receiver of claim 10, wherein the one or more supervisory signals are frequency-modulated.

12. The optical receiver of claim 11, wherein the one or more supervisory signals are complementary.

13. An optical receiver for receiving a multi-polarization signal, the optical receiver comprising:
a photo diode;
a band-pass filter communicatively coupled to the photo diode; and
a radio frequency power detector communicatively coupled to the band-pass filter, wherein the radio frequency power detector is configured to detect an optical power level associated with one or more supervisory signals, wherein each of the one or more supervisory signals is associated with one or more polarization components of the multi-polarization signal.

14. The optical receiver of claim 13, wherein a bandwidth of the band-pass filter is less than or equal to a frequency separation of the one or more supervisory signals.

15. The optical receiver of claim 13, wherein the one or more supervisory signals are amplitude-modulated.

16. The optical receiver of claim 15, wherein the one or more supervisory signals are non-complementary.

17. The optical receiver of claim 15, further comprising a frequency discriminator communicatively coupled to the photo diode, wherein the frequency discriminator is configured to convert a portion of the multi-polarization signal to an amplitude-modulated signal.

18. The optical receiver of claim 17, wherein the one or more supervisory signals are frequency modulated.

19. The optical receiver of claim 18, wherein the one or more supervisory signals are non-complementary.
